(19) United States
(12) Patent Application Publication
(10) Pub. No.: US 2011/0131228 A1
(43) Pub. Date: Jun. 2, 2011

(54) METHOD & APPARATUS FOR IDENTIFYING A SECONDARY CONCEPT IN A COLLECTION OF DOCUMENTS

(75) Inventors: OLGA RASKINA, Arlington, MA (US); Robert Marc Jamison, San Jose, CA (US); Ammiel Kamon, Burlingame, CA (US)

(73) Assignee: Emptoris, Inc., Burlington, MA (US)

(21) Appl. No.: 13/025,218

(22) Filed: Feb. 11, 2011

Related U.S. Application Data
(62) Division of application No. 12/275,949, filed on Nov. 21, 2008.

(51) Int. Cl. G06F 17/30

(52) U.S. Cl. 707/760; 707/E17.073

(57) ABSTRACT

A Methodology for identifying secondary concepts that are included in one or more documents in a collection of documents is disclosed. Training information is manually created from a subset of a collection of documents and used by a primary concept identification function to process textual information contained in the documents included in the collection of documents to identify primary concepts included in the collection of documents. Each of the primary concepts included in the collection of documents is used as input to a secondary concept identification function which results in the identification of secondary concepts included in each of the primary concepts. A query is generated and used as input to both the primary and secondary concept identification functions and the result of both the operation of both of these functions on the query is compared to the identified secondary concepts. The distance between the query and each of the secondary concepts is determined and those secondary concepts that are within a predetermined distance of the query are displayed.

### CROSS REFERENCE TO RELATED APPLICATIONS

This application claims priority to and is a divisional of co-owned, co-pending U.S. patent application Ser. No. 12/275,949, filed Nov. 21, 2008 and entitled “METHOD & APPARATUS FOR IDENTIFYING A SECONDARY CONCEPT IN A COLLECTION OF DOCUMENTS”, the entire contents of which are incorporated herein by reference.

### FIELD OF THE INVENTION

The invention relates to the area of searching for concepts in documents and specifically to searching for secondary concepts contained in primary concepts in a collection of documents.

### BACKGROUND

There has been a long established need to identify conceptual information from among a collection of documents. Historically, it was necessary to perform a manual search through a collection of physical documents to identify all those documents that contained a concept or concepts of particular interest. Such manual searching is labor intensive and returns inconsistent results of varying quality depending upon the expertise of the individual performing the search.

With the advent of network based search engines, such as the Google search engine and others, the process of conducting searches through a collection of documents became much less labor intensive and eliminated some of the inconsistencies associated with the manual searching process. To the extent that the documents containing the concept of interest are available over a network, such as the Internet, search engines can be effectively employed to locate and identify most if not all of the available documents that include the concept of interest. In practice, an individual creates a query by selecting and entering into the search engine some number of keywords. The search engine than employs the query to examine information stored on the network about all available documents and can return a listing of all the documents it identified according to their relevance. The relevance of any particular document can be determined according to a number of different parameters, such as the proximity of one key word to another in the document or depending upon certain Boolean operators used in association with the key words, or other parameters. Unfortunately, most search engines based on key word queries are limited to the extent that they only identify documents that contain concepts that exactly match or are a very close match to the key words in the query. These key word based search engines are not designed with the capability to identify concepts based on key word synonyms or key word polysemy both of which can pollute search results with irrelevant documents or be the cause of incomplete search results. So, although the words “cancel” and “terminate” have similar meanings (they are synonyms), including one or the other in a key word query can return different results. Conversely, the word “bass” can take on different meanings (exhibits polysemy) depending upon the context in which they are used, so a query that includes “bass” may return a listing of documents that include concepts about bass guitars and also return documents that include concepts associated with bass fishing.

In order to overcome the limitations of key word based search engines, a natural language processing methodology referred to as Latent Semantic Indexing or Latent Semantic Analysis (LSI or LSA) was invented that identifies document concepts or topics as opposed to merely identifying the occurrence of key words in a document of collection of documents. Specifically, LSA is described in U.S. Pat. No. 4,839,853 assigned to Bell Communications Research, Inc. and generally can be considered as an automatic statistical technique for extracting relations of expected contextual usage of words (concepts) in a document or a collection of documents. LSA can receive a term or document matrix as input and transform or decompose the information in this matrix (terms as they relate to documents) into a relationship between terms and concepts and between the concepts and the documents. Also, LSA can be employed to compare one document to another document to identify similarities in concepts. Given a query as input to LSA, it is possible to identify a particular concept that is common among a collection of documents. LSA is not limited by key word synonyms or by key word polysemy as are the key word base search engines, and so this technique is capable of returning more complete and more accurate search results.

While the LSA technique can return a listing of documents that contains one or more similar primary concepts or topics, LSA is not able to distinguish or identify subtleties or secondary concepts and topics when processing entire documents as opposed to only a portion of an entire document. The reason for this is that the LSA technique attempts to identify concepts and topics from among a collection of documents. The larger the collection of documents, the more difficult it is for this technique to distinguish among several primary concepts, let alone distinguishing between secondary concepts. Also, some types of documents, such as legal contracts, contain a large number of concepts or subjects which are embodied in individual clauses in the contract. While there may be some similarity between some of the clauses from contract to contract, these clauses tend to be worded very differently which adds to the identification error in the results. As this is the case, it becomes necessary to perform some manual searching to identify secondary concepts included in the results of the LSA operation on a collection of documents in order to identify one or more particular secondary concepts of interest. Such a manual searching step detracts from the advantages realized in employing the LSA technique.

### SUMMARY

It would be beneficial if a searching methodology was able to accurately and efficiently identify secondary concepts of interest from among a collection of documents without the necessity of having to perform a manual searching step. In one embodiment, a method for identifying at least one instance of a secondary concept among a plurality of documents is comprised of creating a primary concept space that includes relationships between different primary concept information identified in the plurality of documents; decomposing the information contained in the primary concept space to create a secondary concept space that includes one or more secondary concepts, each of which is represented in the secondary concept space as a separate vector value; creating a query and translating the query into the secondary concept space where it is represented as a query vector value; comparing the query vector value to each of the secondary concept vector values included in the secondary concept space; and displaying at least one secondary concept that is within a specified distance of the query vector value.

### BRIEF DESCRIPTION OF THE DRAWINGS

FIG. 1 is block diagram of the functional elements in a secondary concept identification system.

FIG. 2 is a block diagram showing the functional elements needed to implement the invention.

FIG. 3 is an illustration of a term-primary topic matrix.

FIG. 4 is an illustration of an LSA result matrix.

FIG. 5 is a screen shot of the I.D. systems user interface.

FIGS. 6A, 6B and 6C are a logical flow chart of the method of the invention.

### DETAILED DESCRIPTION

The ability to identify secondary concepts or concepts contained in one or more documents is very useful when working with a document that is very large or complex or when working with a large collection of documents regardless of the size and complexity of each document. The capability to quickly review one or more documents, such as legal documents or contracts, to accurately identify all or substantially all of one or more secondary concepts of interest is a very powerful capability. One of the problems that magnifies the scope of such a review process is the presence of multiple primary concepts in each legal document. This problem coupled with the very subtle differences between secondary concepts associated with a particular primary concept can make reviewing a collection of legal documents for such secondary concepts very challenging. In the context of the preferred embodiment, a primary concept is any one of the different types of hi-level clauses that are typically included in a legal contract, such as termination clauses, liability clauses, licensing clauses, performance clauses, indemnification clauses and confidentiality clauses. Further, and in the context of the preferred embodiment, secondary concepts include lower-level concepts that are contained within the hi-level primary concepts. For instance, a primary concept such as a “termination clause” can include such secondary concepts as “termination for cause” and “termination without cause”.

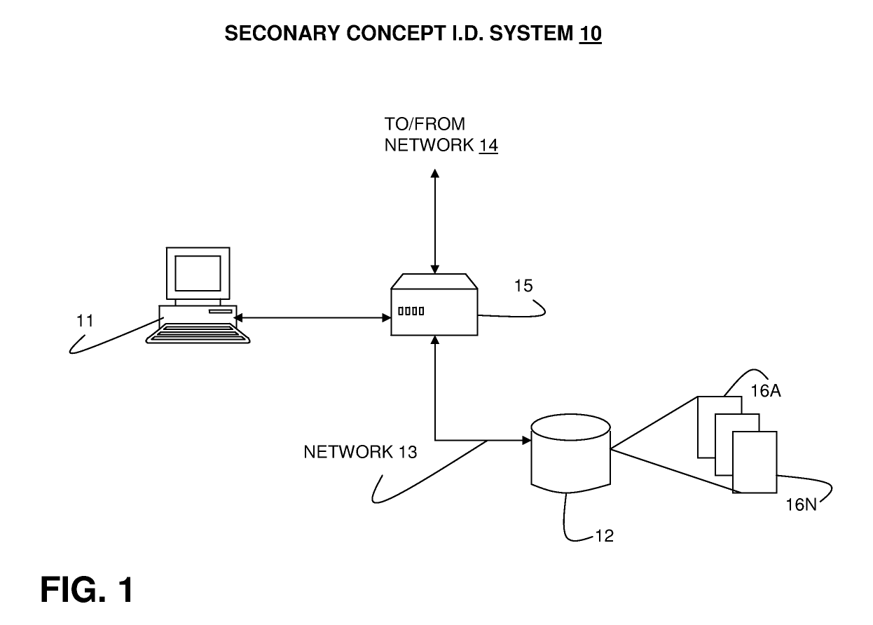

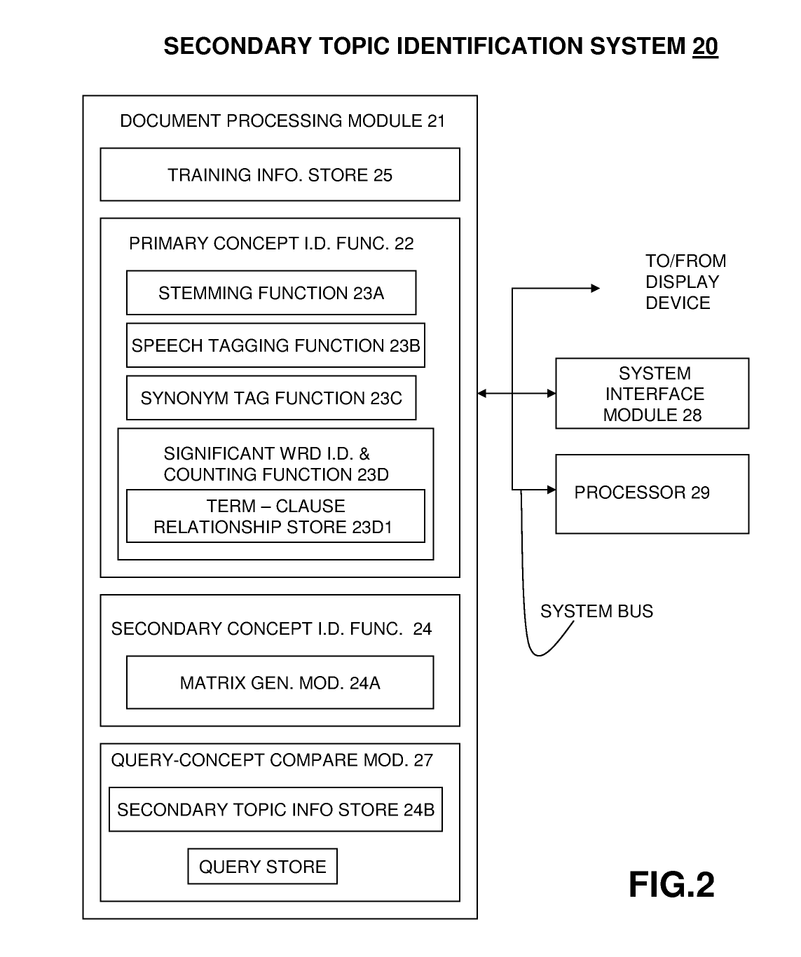

FIG. 1 shows a secondary concept identification system 10 that is capable of identifying secondary concepts in single documents or in a collection of documents. Such a collection of documents can include two or more individual legal contracts for instance and the method of the invention works particularly well on documents with well defined structure such as legal contracts. However, it should be understood that applicability of the invention is not limited to legal contracts. A computational device 11 includes software or firmware that is specifically designed to implement the secondary concept identification technique of the invention. Computational device 11 can be a computer connected to private or public network infrastructure 13 through a switch or router 15 to a store of legal documents, such as those documents stored in document store 12. Store 12 can be any mass storage device suitable for maintaining a collection of legal documents 16A to 16N, with “N” being any number greater than one. Document store 12 permits access to the collection of documents 16A-16N from time to time by individuals with access to the network. While the secondary concept identification technique is describe here in the context of a network environment where the collection of legal documents under review, hereinafter simply referred to as document collection 16, are stored remotely from the computational device 11, the document collection 16 can also be stored on the computational device 11. The functionality necessary to implement the secondary concept identification technique of the invention is described with reference to FIG. 2.

FIG. 2 is a functional block diagram showing functionality that can be employed to implement the secondary concept or topic identification method of the invention. A document processing module 21 resides in a computer memory or other storage device that can be included in the computational device 11 of FIG. 1, but it can also be accessed by an individual using the computational device 11 via a storage device, such as device 12, in the private network or optionally in the public network. For the purpose of this description, it is assumed that the document processing module 21 is located in the computational device 11 of FIG. 1. For the purpose of this description, the terms “concept”, “topic” and “clause” have the same meaning and can be used interchangeably. The document processing module 21 in combination with, among other things, a processor 29, identification system interface 28 and a display device is referred to here as a secondary concept identification system 20. The document processing module 21 includes a training information store 25, a primary concept identification function 22, a secondary concept identification function 24, and a query-concept comparison module 27. The document processing module 21 and the interface 28 can be stored in any storage medium associated with the computational device 11. The primary concept identification function 22 is composed of stemming functionality 23A, part of speech tagging functionality 23B, synonym tagging functionality 23C and significant term identification functionality 23D. In general, the primary concept identification function 22 employs information about one or more primary concepts, that is generated manually during a training session and stored in the training information store 25, to generate one or more primary concept spaces associated with the documents in the collection of documents 16. The one or more primary concept spaces can be grouped according to each primary concept type. Each primary concept type can be equivalent to any one of the different types of clauses that are typically included in a legal contract, such as termination clauses, liability clauses, licensing clauses, performance clauses, indemnification clauses and confidentiality clauses to name only a few. Once the primary concept space(s) associated with the document collection 16 are created and grouped according to type, the secondary concept identification function 24 can operate to decompose the information contained in each of the primary concept spaces to identify secondary concepts included in each of the one or more primary concepts included in the collection of documents 16. The secondary concept identification function 24 can implement latent semantic analysis or indexing (LSI) methodology, which is a technique used for analyzing relationships between one or more documents and the terms or words each of the documents contain to generate a set of secondary concepts. From another perspective, if all of the primary concepts of one type, which can be all of the termination clauses included in each of the documents in the document collection 16, are processed using the LSI methodology, then the result can be the identification of substantially all of the secondary concepts, associated with the primary concept, that are included in the collection of documents 16. In this case, two secondary concepts included in the group of termination clauses can be clauses for “termination for clause” and clauses for “termination without cause”. Once substantially all of the secondary concepts associated with each primary concept in the collection of documents 16 are identified, information about the secondary concept space is stored in the secondary concept information store 24B located in the query-concept compare module 27 for later use. A query, generated by either a user or another application such as a search engine, for instance, is received at the interface 28 and is processed by the secondary concept I.D. module 21 to identify a particular secondary concept of interest, which can be all of the “termination for cause” clauses contained in any of the documents included in the document collection 16, which can be displayed on a display device associated with the computational device 11 of FIG. 1. The query can be processed by the document processing module 21 in a manner similar to that of the document text and the results of this processing are sent to the query-concept compare module 27 where the query information is compared to all of the information stored in the secondary concepts information store 24B located in the query-concept compare module 27. The result of this comparison is a listing of some or all of the secondary concepts of interest that are similar, within some specified parameter, to the query. The listing, in this case, is a listing of substantially all of the “termination for cause” clauses included in all of the documents contained in the document collection 16. The clauses can be listed in order from best scoring match to worst scoring match or any other listing order, such as by date or by company alphabetically, etc.

Continuing to refer to FIG. 2, the operation of the four different functions labeled 23A, 23B, 23C and 23D included in the primary concept identification function 22 will now be described. The stemming function 23A operates on individual words included in the text of the primary concepts included in any one or more of the documents contained in the document collection 16 to reduce each word of the text to their stem, base or root form. The part of speech tagging function 23B operates to mark the words in a text as corresponding to a particular part of speech, based on its definition and its context in the text that it is used. Words can be tagged as nouns, adjectives, verbs, etc. Depending upon the application, it can be necessary to ignore certain parts of speech, such as all of the verbs in the text. In many cases, only the nouns are useful in the identification of primary concepts. The synonym tagging function 23C operates, in this case, to replace particular words in the text with a synonym that the significant term identification function 23D can be trained to recognize. Although the invention is described in the context of the above four functions, 23A-23D, it should be understood that functions with similar but different functionality can be employed to implement the invention and as such the implementation of the invention is not limited to these four functions. The process by which stemming, part of speech tagging and synonym tagging functions operate are well know to those skilled in the area of natural language processing methods and so will not be described here in any detail other than with reference to the following example.

### EXAMPLE TEXT

“Termination of Support Services. ABC.com, at its option, may terminate the Support services at any time without cause . . . with respect to the Software and Documentation which ABC.com has received from Licensor under this Agreement.”

In operation, the synonym tagging algorithm 23C can replace the word “ABC.com” in the example text with “customer” and tag “customer” as “the other party” and “Licensor” can be replaced in the example text with “provider” and tagged as “the party”. After the synonym function 23C, the part of speech tagging function 23B and the stemming function 23A operate on the example text, it can appear as the following processed text: “termin support servic customer mai it option termin support servic ani time without caus . . . respect softwar document which customer ha receive from provider under agreement”.

The significant term identification algorithm 23D can operate on the processed text example above to determine the set of significant terms for a particular secondary concept. In this case, the significant terms can be determine to as “termin”, “customer”, “service”, “without” and “caus”.

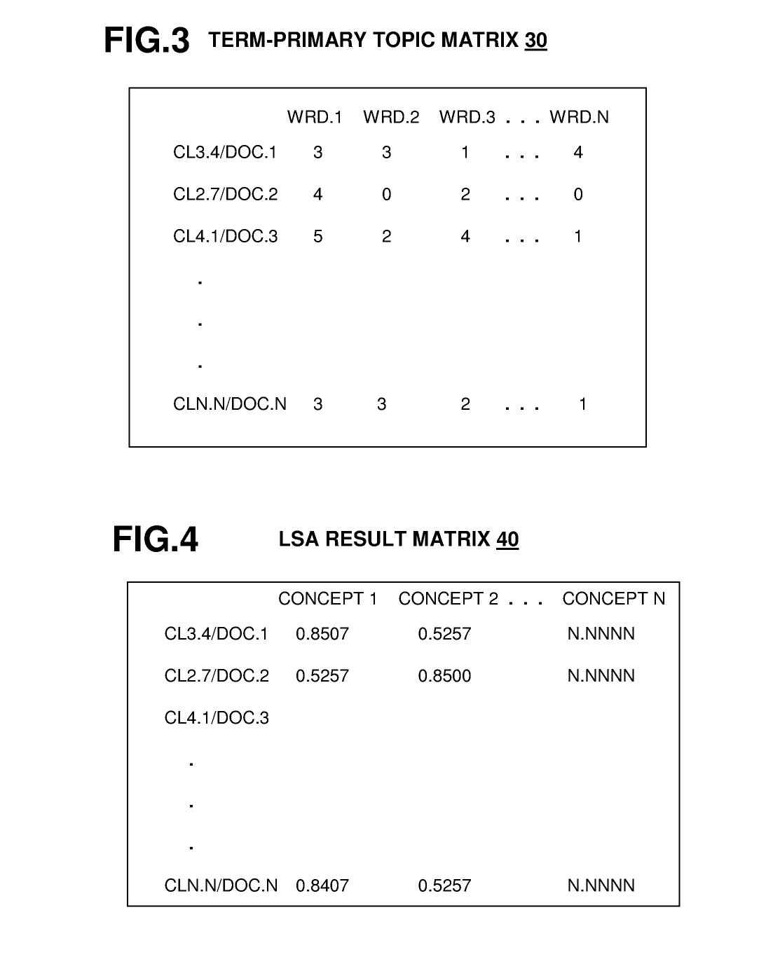

The significant term counting algorithm 23D is employed to identify and count each instance of a significant term in a particular primary concept in all of the documents in the collection of documents 16. This operation is performed for each of the primary concepts contained in the document collection 16 and the results are used by the matrix generation module 24A to generate one or more primary concept spaces one of which is illustrated in FIG. 3 as term-primary concept matrix 30. A single word-primary concept matrix 30 is generated for each identified primary concept. The term-primary concept matrix 30 associates the frequency of each particular significant term with each clause contained in a document in a form that can be used by the LSI technique to identify secondary-concepts of interest. Each row in the matrix 30 represents a particular clause in one document in the collection of documents 16, and each column in the matrix represents a different significant term that can appear in any of the clauses in the collection of documents 16. In this case, the matrix 30 is set up to include “N” number of clauses (CL.1-CL.N) and it is set up to include “N” number of significant terms (Word 1-Word N). As is shown in the matrix 30, “Word 1”, which can be the word “terminat” for instance, is included three times in each of the clauses 1, 2, 3 and “N”. The other words, “Word 2-N” can be any of the other significant terms identified by the I.D. function 23D1.

The information contained in word-primary concept matrix 30 and located in store 23D1 is employed by the secondary concept identification function 24A to identify secondary-concepts in the collection of documents 16. More specifically, the secondary concept identification function 24 can decompose the information contained in the term-primary concept matrix 30. The result of this decomposition is the creation of one or more secondary-concept spaces associated with each of the documents in the collection 16. Information contained in the secondary-concept space is used by the matrix generation module 24 to create an LSI result matrix 40 such as the result matrix shown in FIG. 4. The LSI result matrix 40 is similar in form to the word-primary concept matrix 30 format, but instead of the columns representing individual significant terms, they represent the secondary-concepts identified by the LSI technique as the result of operating on the information contained in matrix 30 (each column can be thought of as a vector which in this case is a concepts relative correlation to one or more clauses). Specifically with respect to matrix 40, each row represents a particular clause, CL.1 to C1.N, in the collection 16 and each column represents a secondary-concept, Concept 1 to Concept N, that is identified by the LSI technique in the collection of documents 16. The information included at the intersection of each row and column is referred to a matrix element. The matrix element can be a numerical value representative of the degree to which the element, which in this case is a secondary-concept, is present in a particular clause. The higher the numerical value, the higher the degree of likelihood is that the secondary-concept is present in a particular clause. As shown in FIG. 4, the matrix element at the intersection of row 1, column 1 is assigned a value of “0.8507” and the matrix element at the intersection of row 1, column 2 is assigned a value of “0.5257”. These values are considered to be vector values for the purpose of later calculations. The significance in the difference between the values of these two matrix elements is that the secondary-concept represented by the value “0.8507” at the intersection of row 1, column 1 is more strongly correlated with “CL.1” than is the secondary-concept represented by the value “0.5257” at the intersection of row 1, column 2. The LSI technique does not provide any indication as to what each of the identified secondary-concepts might mean, but rather simply identifies that there are likely to be some number “N” of secondary-concepts associated with the collection 16 in this case. The value of the number “N” as is relates to the secondary-concepts listed in the matrix 40 will be less than the value of the number “N” of significant terms identified and listed in the matrix 30 of FIG. 3. This reduction in dimensionality between the information provided to LSI as input and the information generated as the result of the LSI technique operating on the input is a characteristic of the LSI technique. The numerical values associated with each of the elements of matrix 40 are stored in the secondary-concept information store 24B for later use.

In order for the secondary concept identification system 10 to identify secondary concepts of interest, it is necessary to create one or more queries that include some key words or a phrase that characterizes the secondary concept of interest and it is also necessary to select a primary concept of interest. The secondary concept I.D. function 24 operates to translate the one or more queries into a secondary concept space and information contained in this space is placed into a matrix format similar to the format of matrix 30 and stored in the query store in the query-concept compare module 27. More specifically, each word included in a “query” is used by the primary concept identification function 27 of FIG. 2, to identify and count in all of the clauses or primary concepts of the documents in the collection 16, how many times each word in a “query” occurs in each primary concept. Then the secondary concept identification function 24 uses these results to identify and place values on secondary-concepts associated with the words in a query. The processed query information, which is a set of values is then stored in a query-store in the query-concept compare module 27. A “query” in this case can include the two words “cancellation” and “convenience” and this query can be assigned a value of “0.9500”, for instance (there can be more than one value assigned to the query depending upon the complexity of the query). The query-concept compare module 27 operates to take the value of one or more of the created and stored queries, which in this case is “0.9500” and compares this value to the values of each of the elements in the matrix 40 to identify all those values contained in the matrix 40 that are within a specified “distance” or numerical value of the query value “0.9500” or values. The distance between a query vector and a LSI result vector can be determined by calculating the dot product of the two vectors or by calculating the cosine between the two vectors. The specified distance in this case can be 0.1. In this case, only one of the elements, the element with a value of 0.8507, in the matrix 40 of FIG. 4 is within the specified distance, so the clause or clauses in the documents “Doc. 1”, “Doc. 2” . . . “Doc. N” are displayed in some order determined by the user of the system 10.

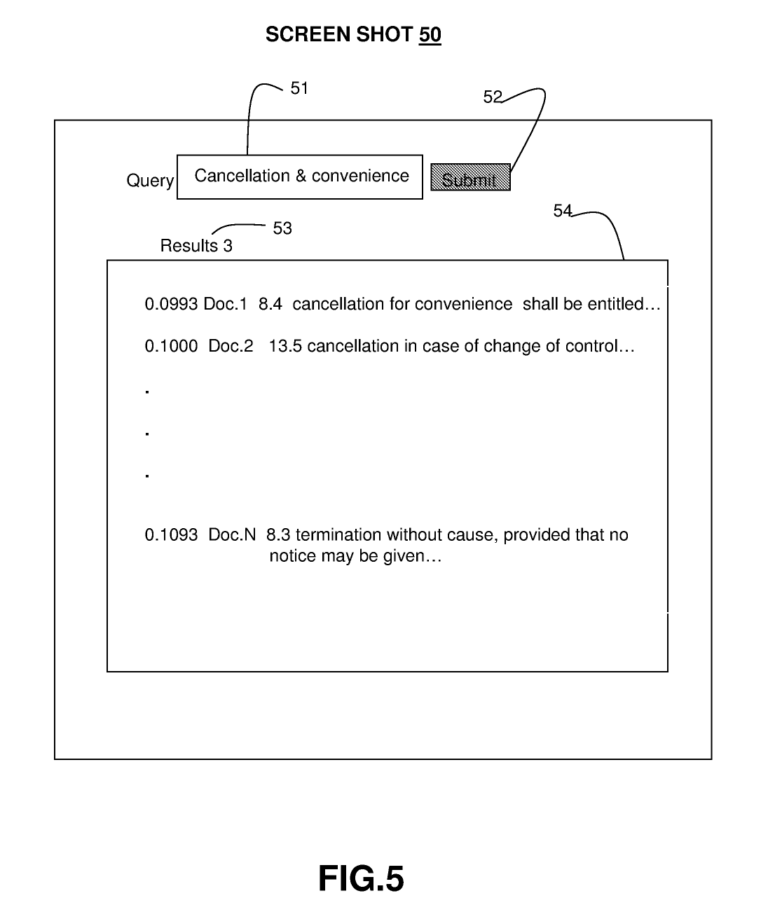

FIG. 5 is an illustration of a screen available to a I.D. system 10 user. This screen shows a query entry field 51 that displays the selected query words which in this case are “cancellation” and “convenience”, a submit button that is selected to submit the query to the I.D. system 10, a results field 53 that displays an integer value indicative of the number of results that are displayed in the results display field 54. For illustrative purposes, the results display field 54 shows six resultant secondary concepts, which are six separate clauses included in six different documents or contracts. The resultant six clauses are displayed, in this case, in descending order, closest clause first, according to their relative distance from the query. So, for instance, the first clause displayed in the results field 54 is the one most calculated to most closely correlated to the query, “cancellation & convenience”.

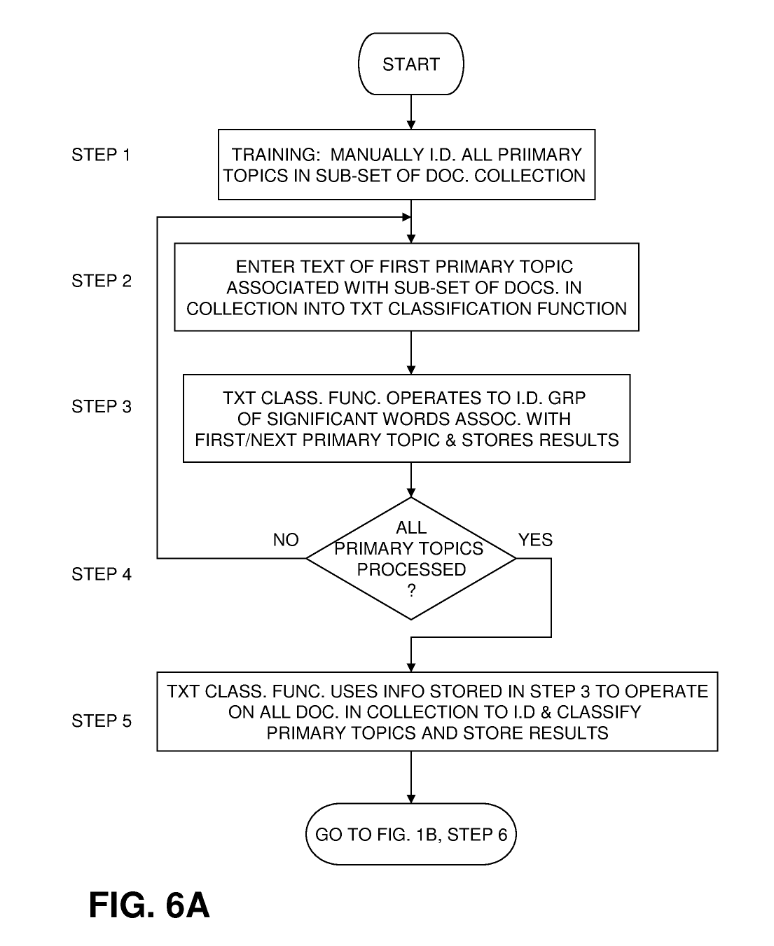

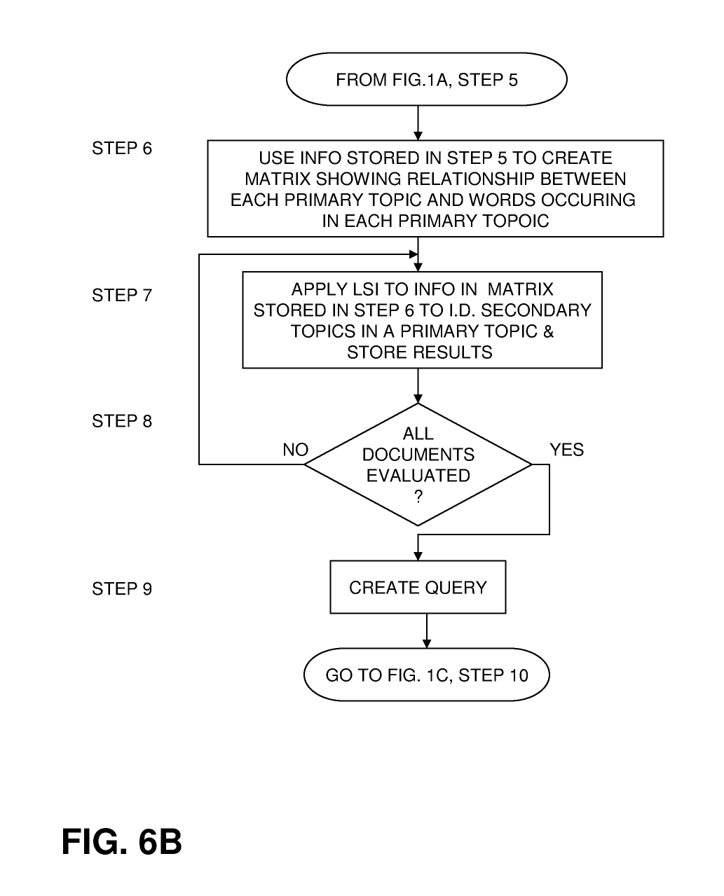

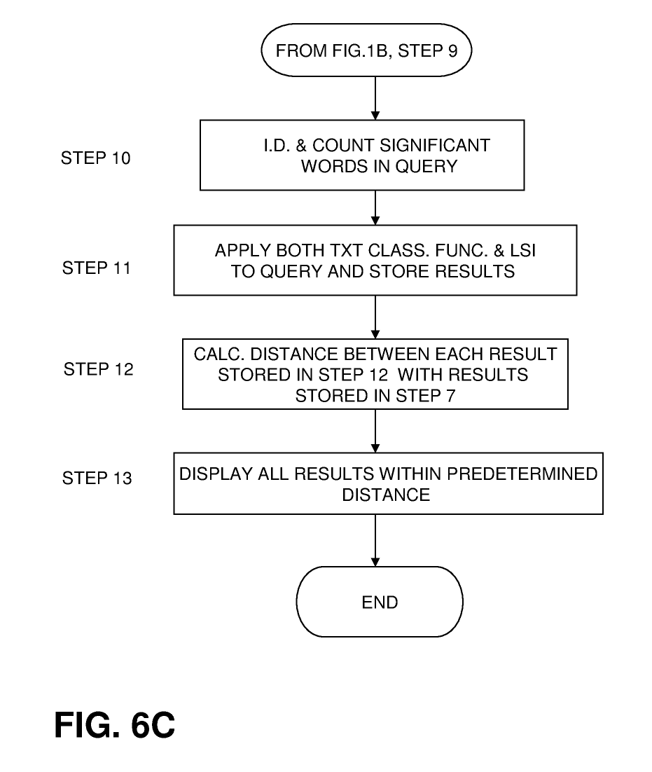

One embodiment of the process employed to practice the invention is described with reference to the logical flow diagram of FIGS. 6A, 6B and 6C. It is necessary to manually train the I.D. system 10 in order for it to perform accurately and steps 1 to 4 describe this training process. Step 1 includes a portion of the manual training step in which a user of the system 10 reviews the contents of a subset of the documents included in the document collection 16 to identify primary concepts (clauses) of different types, or at least of the clause types that are of interest to the user. The text of the clauses included in each primary concept are stored in the training information store 25 of the document processing module 21 of FIG. 2. In step 2, the text of each clause contained in one primary concept is entered into the document processing module 21 of FIG. 2 where the text is operated on by the stemming function 23A, the speech tagging function 23B and the synonym tagging function 23C. The result of step 2 is the generation of modified text that in step 3 the significant term I.D. and counting function 23D operates on to identify and then count all of the significant terms that appear in each clause contained in the primary concept. The result of step 3 are groups of significant terms, each group being associated with a primary concept and stored in store 23D1.

The text of the training clauses contained in each of the primary concepts is processed as described with reference to steps 2 and 3 and when all of the training text for all of the primary concepts has been processed and the results stored, the process proceeds to step 5. In step 5, the text of all the documents in the document collection 16 is entered into the primary concept identification function 22 which operates on this text, significant term group by significant term group, to identify each of the clauses in the collection of documents that are associated with each particular primary concept. More specifically, the primary concept identification function 22 employs the significant terms identified in step 3 and stored in step 5 to identify the occurrence and frequency of occurrence of each significant term in each clause included in each primary concept.

Referring to FIG. 6B, in step 6 the results stored in step 5 are operated on by the matrix generation module 24 to create one or more term-primary concept matrixes such as matrix 30 of FIG. 3 and the information in the matrix is stored in store 23D1. Each matrix 30 only includes information relating to one primary concept. In step 7, the secondary concept identification function 24 operates on the information contained in each of the one or more matrixes 30 to identify substantially all of the secondary concepts included in each of the primary concepts. Depending upon the care exercised in the training phase of this process (steps 1-4) more or fewer of the secondary concepts can be identified by the secondary concept identification function 24, and the care exercised in the training phase can vary according to the individual who is performing the training phase. At any rate, the results of the LSI operation in step 7 are placed into a matrix format by the matrix generation module 24 and stored in the secondary concept information store 24B in the query-concept compare module 27. A detailed description of how the secondary concept identification function 24A operates to identify concepts, which in this case are secondary concepts, will not be undertaken in this application as the design of LSI methodologies are well know to those skilled in the field of natural language processing. In step 8, if all of the documents in the collection 16 are evaluated by the secondary concept identification function 24, then the process proceeds to step 9, otherwise the process returns to step 7 and the next group of clauses associated with another/the next primary concept are evaluated by the secondary concept identification function 24.

Continuing to refer to FIG. 6B, at this point, all of the information has been generated and stored that is needed to initiate a search through the collection of documents to identify substantially all of the clauses in the collection of documents 16 (contracts) that display a secondary concept of interest. In this case, the secondary concept of interest can be all clauses that recite language directed to termination of a contract without cause. Next, in step 9, a query such as “termination without cause” is created and entered into the document processing module 21. This query is created with the intent that the I.D. system 10 will search through all of the documents in the collection 16 to locate the clauses that include language that is directed to the subject of the query, which in this case is “termination without cause”. In this case, the query is created that includes the two words “cancellation and convenience” with the intent that substantially all of the clauses in the collection of documents 16 will be identified that include language that is directed to the termination of a contract at the “convenience” of either or any of the parties to the contract.

Referring now to FIG. 6C, in steps 10 and 11, the words in the query generated in step 10 are processed by the primary concept I.D. function 22 and the secondary concept identification function 24 in the same manner to arrive at the same results (which is a vector value stored in a matrix) as the text of the training clauses or the text of any of the clauses that is entered into the primary concept I.D. function 22 and the secondary concept identification function 24. This vector information relating to each secondary concept identified by the secondary concept identification function 24 is stored in a query-matrix in the query store contained in the query-concept comparison module 27. In step 12, the distance between each vector in the query-matrix and each vector in the LSA result matrix associated with the selected “termination without cause” clauses are calculated and the results are displayed in the results display window 54 as shown in FIG. 5.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method for identifying at least one instance of a secondary concept in a plurality of documents comprising:
training a primary concept identification function to identify one or more significant terms associated with each of one or more primary concepts in a sub-group of the plurality of documents;
employing the trained primary concept identification function to detect the frequency of substantially all of the significant terms associated with each one of the one or more primary concepts in the plural documents;
defining a relationship between all of the one or more significant terms and at least one of the primary concepts and storing the contents of the defined relationship as a primary concept space;
processing the contents of the stored primary concept space using a secondary concept identification function to identify at least one secondary concept associated with at least one instance of a primary concept and calculating a vector value for it and storing the at least one vector value as a secondary concept vector value in a secondary concept space;
creating a query and translating the query into the secondary concept space and calculating a vector value for it and storing the vector value as a query vector value in the secondary concept space; comparing the query vector value to each of the at least one secondary concept vector values; and
displaying at least one secondary concept that is within a select distance of the query vector value.

2. The method of claim 1 wherein training the primary concept identification function includes manually identifying at least one primary concept in a collection of documents and applying one or more natural language processing functions to the at least one manually identified primary concept to identify at least one significant term.

3. The method of claim 2 wherein the at least one significant term is a word that appears in the text of the primary concept more than a predetermined number of times.

4. The method of claim 1 wherein the defined relationship is a multidimensional matrix.

5. The method of claim 1 wherein the primary concept identification function includes at least one natural language processing function.

6. The method of claim 5 wherein the at least one natural language processing function is one of a stemming function, a part of speech tagging function, a synonym tagging function and a significant word identification function.

7. The method of claim 1 wherein the secondary concept identification function is a latent semantic indexing process.

8. The method of claim 1 wherein comparing the query vector value to each of the one or more secondary concept vector values is comprised of one or calculating the dot product or the cosine between the query the query vector value and a secondary concept vector value.
